(19) United States
(12) Patent Application Publication
(10) Pub. No.: US 2009/0309367 A1
(43) Pub. Date: Dec. 17, 2009

(54) ROTATABLE ENERGY GENERATION UNIT FOR GENERATING ELECTRIC ENERGY FROM A WATER FLOW

(75) Inventors: Norman Perner, Neu-Ulm (DE); Benjamin Holstein, Heidenheim (DE)

Correspondence Address: BAKER & DANIELS LLP;111 E. WAYNE STREET, SUITE 800, FORT WAYNE, IN, 46802, US

(73) Assignee: VOITH PATENT GmbH, Heidenheim (DE)

(21) Appl. No.: 12/300,384

(22) PCT Filed: Nov. 23, 2007
(86) PCT No.: PCT/EP07/10174

§ 371 Date: Nov. 11, 2008

(30) Foreign Application Priority Data
Jan. 16, 2007 (DE) 10 2007 002 338.5

(51) Int. Cl. F03B 13/00

(52) U.S. Cl. 290/54; 416/170 R

(57) ABSTRACT

The invention relates to a rotatable power generation plant for generating electric power from a flow of water, comprising:
a water turbine;
an electric generator which is driven by the water turbine;
a support body which is associated with a first axis;
a nacelle body which is associated with a second axis bent off relative to the first axis and is movable relative to the support body;
a connection cable which extends from the electric generator through the nacelle body to the support body;
a hinged joint between the support body and the nacelle body with a device which transmits a rotational movement of the nacelle body about the first axis associated with the support body into a rotational movement of the nacelle body about the second axis associated with the same in such a way that twisting of the connection cable remains limited.

The invention relates to a rotatable power generation plant for generating electric power from a flow of water, especially from a sea or running-water current.

Submersed power generation plants which are arranged independent of dam structures and which are driven by the kinetic energy of a flow of water, especially a sea current, represent a large potential for utilizing regenerative power sources. Even a low flow velocity of approximately 2 to 2.5 m/s can be utilized for economic power generation as a result of the high density of the flow medium. Such flow conditions can either be present as tidal currents or other sea currents are utilized which can reach economically exploitable velocities especially at straits. Such currents can drive tidal-current power plants which have a similar configuration as wind power plants, which means that blade wheels with rotor blades are used as water turbines. Other water turbine concepts such as vertical turbines and axial-flow tube-type turbines are possible. In addition to the area of application of power generation from sea currents, such free-standing submersed power generation plants can also be used in running waters where as a result of requirements imposed by environmental protection or commercial shipping it is not possible to build any barrages with water turbines built into the same.

GB 2 431 207 A1 describes a submerged turbine with a support body and a nacelle body for receiving a turbine rotor. The nacelle body is linked to the support body, so that it can be swiveled between an upright and a horizontal position.

U.S. Pat. No. 6,104,097 describes a turbine system. It comprises a vertical support body and a horizontal nacelle body fixed to its upper end.

When a tidal current is used for power generation, then it is necessary to adjust the power generation plant to the changing directions of flow. Different approaches have been pursued to achieve this object, one of which is to arrange the water turbine in such a way that the flow can approach the same from different directions, with the turbine not being arranged in a rotatable manner. When a propeller-like water turbine is used for example, then this can be caused by rotating the turbine blades by 180° for example. An alternative approach for adjustment to different flow directions is to rotate the water turbine. In order to avoid the for this concept complex gear solutions and rotational feedthroughs for connection to the rotatably arranged water turbine with a stationary generator, the complete unit consisting of water turbine, e.g. one in the form of a propeller, and the electric generator are moved as a unit along with the flow. Known systems comprise submerged installations which are provided with floating bodies and which are anchored via cable systems to the ground of the sea or the ground of the running water. Such an approach allows for automatic adjustment to a changeable direction of flow. Not only flow from two main directions but also incoming flow from the entire full circle can be utilized.

The disadvantageous aspect in the known free-standing rotatable flow power plants is that as a result of a continuously repetitive rotational movement there will be a continually increasing degree of twisting of such components which represent a connection to stationary elements and which cannot be arranged themselves through hinged joints. One example is the connection cable for producing the mains connection of the electric generator and further cable connections which produce a connection to a central control and monitoring device.

The invention is therefore based on the object of providing a free-standing power generation plant for generating electric power from a water current which utilizes the kinetic energy available in the water current with high efficiency, with the water turbine following in the case of changeable directions of the current without cable connections being subjected to any strong twisting in the case of repeated rotational movements about a stationary point of the unit. Moreover, the power generation plant is to be provided with a simple configuration in respect of design and construction. This object in accordance with the invention is achieved by a rotatable power generation plant with the features of the independent claims. Advantageous embodiments are obtained from the sub-claims.

The invention is based on the initial finding that an efficient free-standing power generation comprises a rotatable nacelle for receiving an electric generator which is driven at least indirectly by a water turbine which can move rotatably together with the current about a stationary connection point. Accordingly, the water turbine is made to follow up either actively through an actuating drive or passively by the current pressure and always adjusts optimally to the respectively existing current conditions. An embodiment is especially preferred in which the nacelle and thus the unit consisting of water turbine and electric generator have a certain distance to such a pivot in order to arrange the rotational plane of the water turbine at such a distance from the further support structures that the same is flowed against with as little impairment as possible. This is implemented by using a nacelle body which is provided between the hinge point and the nacelle and which represents a rigid element in the form of a pipe or a support structure in an especially preferred way.

When the nacelle body and the nacelle attached thereto, including the electric generator and the water turbine, perform a rotational movement in a substantially horizontal plane about a pivot for following up the current, there will inevitably be a twisting of the connection cable unless merely a reciprocating movement is performed, which means a regular reversal of the sense of rotation. Said twisting runs from the electric generator to the connection point and further to the support body adjacent to the same along the land connection. In order to solve this problem, the inventors have recognized that twisting can be prevented when the nacelle body and the electric generator fixed in the same and thus also the part of the connection cable extending from the connection point to the electric generator performs synchronously to the rotational movement in a horizontal plane a rolling-off motion with a rate of rotation corresponding to the follow-up motion.

The principle can be explained by reference to a flexible tube which is tightly held at both ends in the kinked position. When trying to twist the one end about the axis of the other partial section, there will either be a twisting of the flexible tube or a rotational movement of the rotating end about its own axis must be permitted. This means when applied to a generic power generation installation that the same has a support body that is stationary and can be anchored in the form of a pillar on the ground of the sea. A hinged joint to a nacelle body is located on said support body, which nacelle body holds the nacelle and thus the unit of electric generator and water turbine at the end averted from the hinged joint. A connection cable runs to the support body from the electric generator in the nacelle along or through the nacelle body and via the hinged joint and from there further to the power supply point for the electric power generation plant. This connection cable will not be subject to any twisting when the hinged joint has a device which upon occurrence of a rotational movement of the nacelle body and thus the nacelle of the power generation plant about the support body for current follow-up simultaneously performs a rotational movement of the nacelle body about its own axis and thus a rotational movement of the partial section of the connection cable located in said nacelle body and the electric generator held in the same synchronously to the follow-up movement. In other words, this ensures that in the case of an allocation of a first axis to the support body, about which a rotational movement is performed when following up the current, and a respective allocation of a second axis to the nacelle body, the rate of rotation about the first axis must correspond to the rate of rotation about the second axis, so that for performing the rotational movement about the first axis the nacelle body simultaneously performs a rolling-off movement within the terms of two mutually combing conical gearwheels in a bevel gear with a gear ratio of 1:1.

It is noteworthy that the first axis which is allocated to the stationary support body and the second axis allocated to the nacelle body generally need not coincide with the actual body axes, which is especially the case when a multi-part or bent structure is realized. Instead, the determination of a first axis and a second axis is merely used for illustrating the rotational axes about which a synchronous rotational movement must be performed in order to prevent any twisting of the cables. Moreover, the first axis and the second axis need not necessarily stand at a right angle with respect to each other and it is possible that the nacelle body follows in its movement a funnel-shaped generating curve.

In order to realize a hinged joint which fulfils the requirements in accordance with the invention, it is possible to use an elastic connection which can absorb the tensile or pressure forces occurring by the water current in the direction of the second axis and thus perform the required synchronous rotational movement of the nacelle body and thus the electric generator about the second axis in the case of a rotational movement about the first axis which is associated with the support body. Both of these functions are separated according to an alternative embodiment. The transmission of the rotational movement from the first axis to the second axis occurs by interaction of positive or non-positive elements. In the simplest of cases, these will be mutually combing gearwheels, e.g. two conical gearwheels. The further function of securing the nacelle body to the support body and the take-up of propulsive and pressure forces introduced via the water turbine along the second axis can occur via an element separated from the same within the terms of a tie, which ensures that the positive and non-positive connection is continually maintained for realizing the synchronous rotation about the first and second axis.

The idea in accordance with the invention can be used both for active follow-up in which the power generation plant is forcibly guided about the first axis which is associated with the support body, as well as for passive follow-up based on the pressure of the current. In the first case it is possible to arrange the power generation plant as a lee-side or current-side runner. Only lee-side runners are used in the case of passive follow-up. An angular offset for the setting which is optimal for a specific direction of current occurs in the concept in accordance with the invention in the case of a passive follow-up as a result of generator moments. It arises in such a way that the generator moment of the electric generator is transmitted via its anchoring to the nacelle body, thus giving rise to a torque about the second axis which is associated with the nacelle body and which is translated into a torque about the latter, which means the axis of the support body, as a result of the inventive synchronous axial coupling between the first and the second axis. This leads to a certain rotational motion about the second axis from the optimal position, whereupon counter-forces are generated through the applied current until a balance is obtained at a specific angular offset. Said angular offset is usually only very low in a conventional design of a plant and assumes only a few degrees. Moreover, the dynamic pressure forces resulting from the incoming flow can be increased in a purposeful way by flow guide structures such as fins and rudders. A further suitable measure is to provide the nacelle body of a lee-side runner with the longest possible configuration, so that as a result of the large distance from the hinged joint the already existing structures which consist of nacelle body and nacelle as well as that of the water turbine will lead to significant rudder forces once an angular deflection from the optimal position is caused for the existing current.

Moreover, angular offset as described above can be avoided until reaching a balance point in accordance with the invention with passive follow-up in such a way that oppositely revolving water turbines are used and the generator forces of the respectively associated electric generators will balance each other out.

The invention is now explained in closer detail by reference to the drawings, wherein:

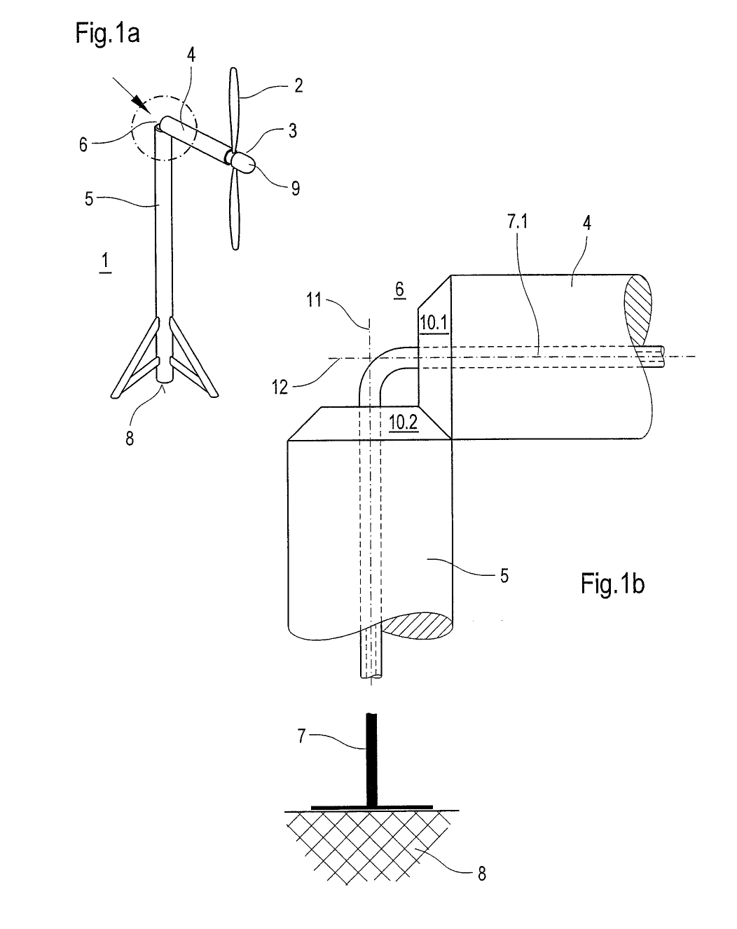

FIGS. 1a and 1b show the principle of action of a hinged joint in accordance with the invention between the support body and the nacelle body of a current power plant, in which the follow-up of the nacelle body leads to a synchronous rotational movement about its own axis.

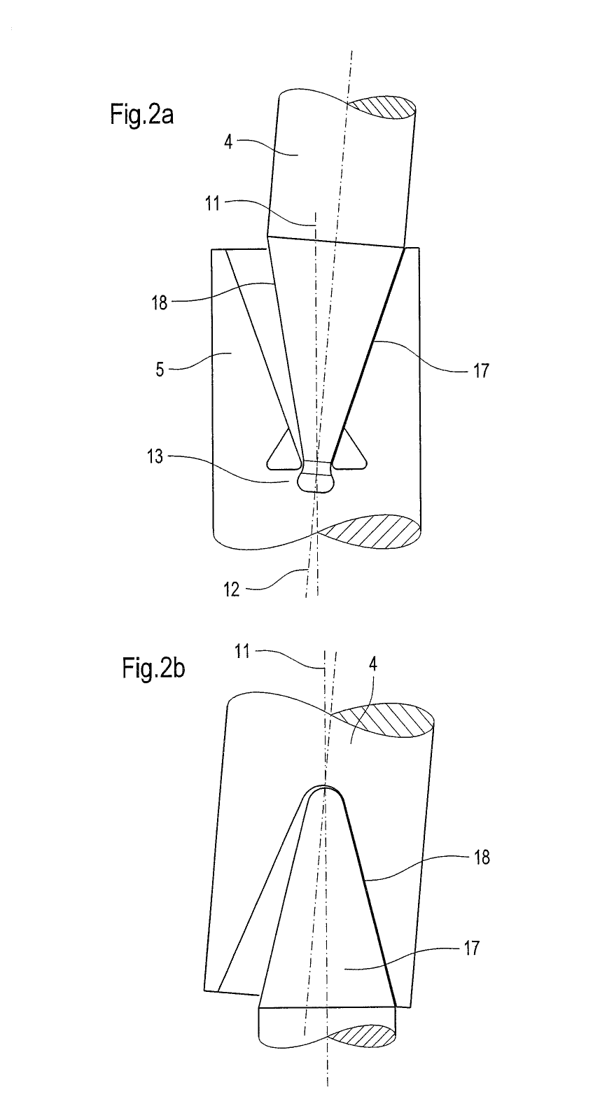

FIGS. 2a and 2b show different embodiments of first and second positive and non-positive elements for realizing the synchronous movement in connection with a rigid central tie.

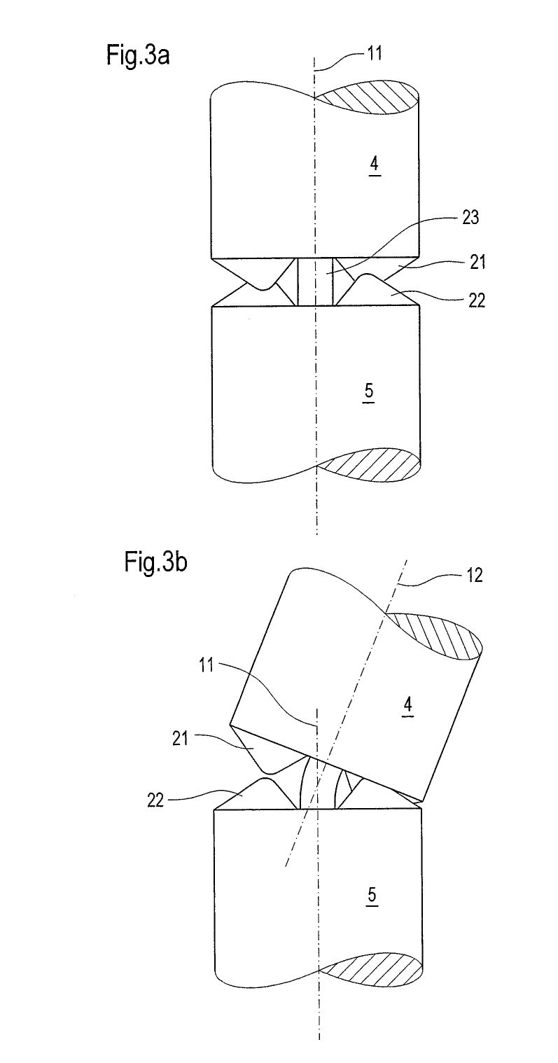

FIGS. 3 and 3b show an embodiment with a flexible central tie.

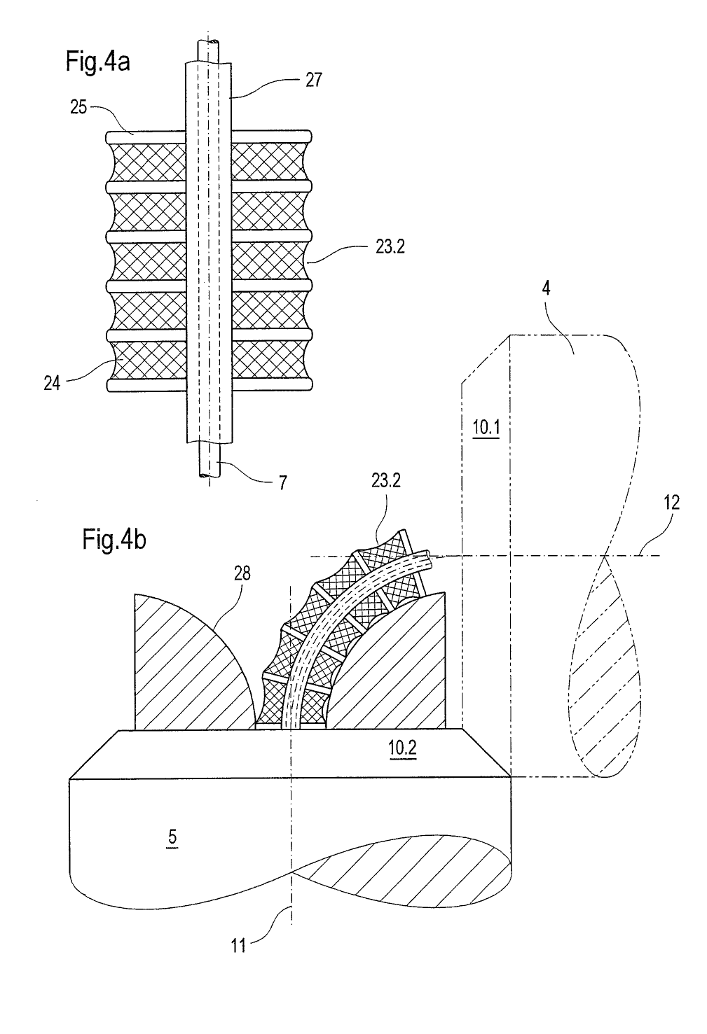

FIGS. 4a and 4b show an embodiment with a central flexible tie on a run-off surface.

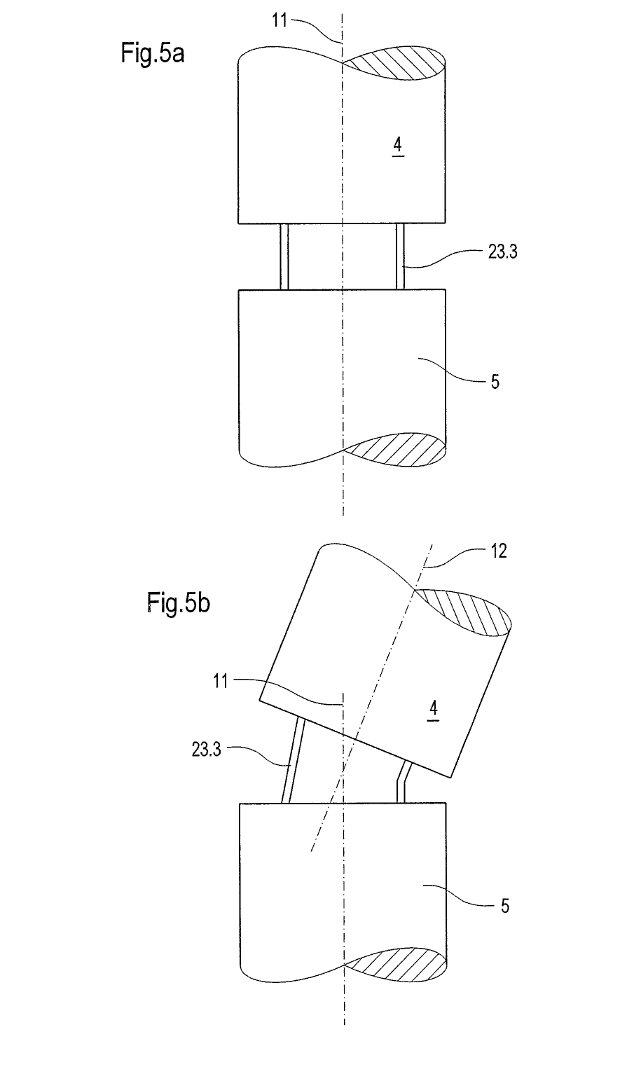

FIGS. 5a and 5b show an embodiment of the hinged joint which is realized only by means of an elastic component.

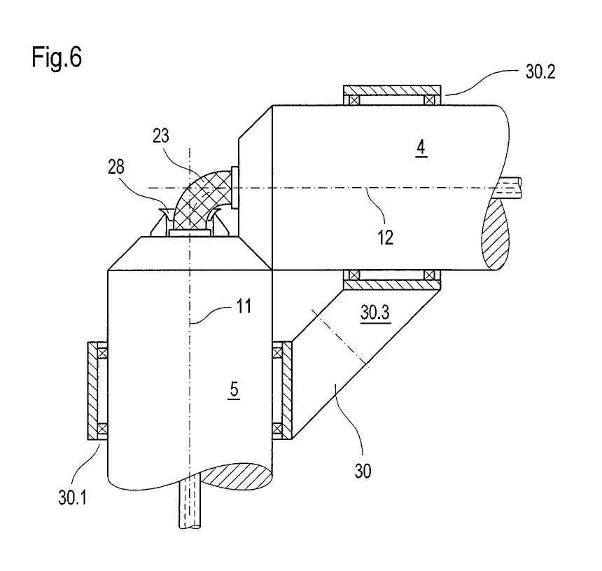

FIG. 6 shows further guide elements in the form of a securing means against upward tilting.

FIGS. 1a and 1b show a schematic simplified view of the principal components of the power generation plant 1 in accordance with the invention. A water turbine 2 which can be arranged in the form of a propeller is used for converting kinetic energy from the water current. An electric generator 3 is driven by the same which is received in a nacelle 9 or whose housing forms the nacelle. Nacelle 9 is associated with a nacelle body 4 which is used to space the water turbine from a support body 5. Said support body 5 can be a support column or a lattice tower with an anchoring on the ground 8 of the sea for example. A floating unit can also be provided alternatively as a support body 5, which floating unit is anchored via hawsers and is thus substantially stationary and resistant to rotation against the ground 8 of the sea. A hinged joint 6 is applied between the nacelle body 4 and the support body 5 which is arranged in accordance with the invention in such a way that an active or passive follow-up of the water turbine 2 with the direction of flow of the driving water current is converted into a synchronous rotational movement of the nacelle body 4. The principle of this rolling-off motion is shown in FIG. 1b which shows an enlarged partial sectional view of FIG. 1a in the area of the hinged joint 6.

FIG. 1b shows in detail a first axis 11 which is associated with the support body 5 and a second axis 12 which is associated with the nacelle body 4. Preferably, the first axis 11 extends substantially perpendicularly. The follow-up of the water turbine 2 with the direction of flow means that the second axis 12 which is associated with the nacelle body adjusts substantially parallel to the direction of flow. An arrow is shown in this respect in FIG. 1a which shows the incoming flow of the illustration lee-side runner. A rotation about the first axis 11 of the support body 5 is performed for enabling the follow-up of the power generation plant 1, with the electric connection cable 7 extending from the generator 3 through the nacelle body 4, the hinged joint 6 and the support body 5 not being subject to any twisting when the nacelle body 4 co-rotates about its own axis with the torsionally rigidly connected electric generator 3 and the electric connection cable 7 which is attached thereto. This requires the nacelle body 4 to roll off on the support body 5 at a gear ratio of 1:1 (u=1). For this purpose, the conical rolling-off surface 10.1 as shown in FIG. 1b is provided in an exemplary way on the nacelle body 4 and according to 10.2 on the support body 5. Preferably, the circumference of the rolling-off surfaces 10.1, 10.2 coincides in order to realize the same rates of rotation. In order to prevent slippage, these surfaces are preferably provided with a toothing or with claws and respective recesses on the counterpart or a friction lining. Generally, there is thus a positive and/or non-positive connection to realize rolling off and thus the required synchronous movement. When there is a gearing, the tooth pairing must use gearwheels with corresponding number of teeth for the condition u=1.

According to an embodiment, the condition of a 1:1 gearing ratio between the first and the second axis 11, 12 is ameliorated in the respect that independent from the rotation about the first axis 11 of the support body 5 the twisting of the connection cable 7 is limited between the nacelle body 4 and the support body 5. It can therefore still be tolerated that a small rotational angle about the first axis 11 is not converted directly into a synchronous rotation, but that the same only commences after a specific degree of twisting. This is the case for example when elastic coupling elements counteract a twisting and force a synchronous movement from the first to the second axis only in the case of sufficient restoring forces.

The principal illustration of FIG. 1b does not show the elements of the hinged joint in detail which are used to produce the contact between the two roll-off surfaces 10.1 and 10.2 during operation. Tensile forces must be intercepted especially in the case of a current-side runner which are forwarded by the water pressure onto the water turbine 2 and thus onto the hinged joint 6. Anchoring elements can be provided for this purpose in the hinged joint 6 which are arranged in the form of a central rigid tie 13 according to FIGS. 2a and 2b for example. It is in rigid connection with the nacelle body 4 at the one end and in interlocking rotatable connection with the support body 5 at the other end which is realized according to the illustrated embodiments via a groove-and-ring pairing. Moreover, a shape has been chosen in which the first axis 11 and the second axis 12 are not rectangular, but stand at an angle <90° with respect to each other, which means that the nacelle body 4 describes a V-shaped generating curve during the follow-up of the water turbine relative to the incoming flow. It follows from this that the nacelle body 4 has a rolling-off surface which revolves on an associated rolling-off surface of the support body 5. As a result of the water pressure, a continual contact is ensured between these two surfaces that roll off one another. They can further be arranged in such a way that slippage is prevented and each rotational movement about the first axis 11 is connected with a synchronous rolling movement (with u=1) about the second axis 12. Different gearings or friction linings can be considered here. For the embodiments as shown in FIGS. 2a and 2b, the rolling-off surfaces are arranged conically and extend with different cone angles. In the case of FIG. 2a, the first cone surface 18 associated with the nacelle body 4 has a lower angle of opening in comparison with the second cone surface 17 which is associated with the support body 5. The opposite case applies to FIG. 2b. It is preferably ensured for all embodiments that the gear ratio for the rotation about the first axis 11 to the rotation about the second axis is close to u=1. This can be ensured by a respectively chosen gearing.

The alternative embodiment according to FIGS. 3a and 3b differs from the preceding embodiments in that a flexible tie 23 is used instead of a rigid central tie, which flexible tie takes up the tensile forces but is simultaneously bendable in the lateral direction. In the simplest of cases this is a chain or preferably a multi-layer wire mesh. For realizing first and second interlocking elements, mutually engaging projections 21, 22 are shown at the end surfaces of the nacelle body 4 and the support body 5, which projections level out towards the outside circumference, so that in the case of a bending of the nacelle body 4 relative to the support body 5 the angle of tilt is determined by the progression of the profile of the projections 21, 22 and the preferably plane contact surfaces on the counterpart and the play predetermined by the flexible tie 23. The current forces will bring this angle to a stop, so that a secure entrainment of the mutually engaging projections and the synchronous rolling-off in accordance with the invention is ensured with u=1.

A further development of an arrangement with a flexible central tie is shown in FIGS. 4a and 4b, with FIG. 4a showing a segmented tie 23.2 in the non-mounted state and FIG. 4 the same in the mounted state. The same consists in detail of a sequence of elastic segments 24 and rigid segments 25 and a bendable protective sheath 20 for the connection cable 7 which extends through a duct 27 in the interior of the segmented tie 23.2. In the mounted state, a bent bearing surface 28 is associated with the tie 23.2 which in conjunction with the flexible, centrally arranged tie 23.2 ensures secure contact of the first conical rolling-off surface 10.1 on the respective counterpart, which is the second conical rolling-off surface 10.2. A further development of a flexible tie is shown in FIGS. 5a and 5b. In this respect there are surfaces of the nacelle body 4 and support body 5 which roll off on each other. Instead, the conversion of a rotational movement about the first axis 11 into a synchronous rotation about a second axis 12 is caused exclusively by a flexible tie/joint element 23.3 which is arranged for example as an elastic annular component with an adjusted diameter and a sufficient wall thickness. In case of operation, as is shown in FIG. 5b, one side of said flexible tie/joint element 23.3 is expanded, whereas the opposite side is subjected to a compression and the entrainment effect is caused by elastic forces which counteract twisting. Minor twisting is permitted for this embodiment, but the restoring forces will definitely ensure a limitation of the twisting of the connection cable with increasing torsion of the flexible tie/joint element.

Further guide elements can be provided within the scope of expert knowledge which ensure the secure mutually rolling of the end sections of the support body 5 and the nacelle body 4. A securing means 30 against upward tilting is shown as an example in FIG. 6, which securing means comprises a first circumferential ring 30.1 for rotatably enclosing the support body 5 and a second circumferential ring 30.2 for rotatably enclosing the nacelle body 4. These elements are preferably provided with bearings and prevent a change of the angular setting between the nacelle body 4 and the support body 5 as a result of a web 30.3 connecting the two elements. According to the arrangement as shown in FIG. 6, the central flexible tie 23 which is additionally supported by the bent bearing surface 28 is merely used to take up a tensile and pressure load along the first axis 11 of the nacelle body 4. It is also possible however to integrate this function in then securing means 30 against upward tilting and to completely replace said central tie 23. This is not shown in detail in FIG. 6.

### LIST OF REFERENCE NUMERALS

1 Power generation plant
2 Water turbine
3 Electric generator
4 Nacelle body
5 Support body
6 Hinged joint
7 Connection cable
8 Ocean ground
9 Nacelle
10.1, 10.2 Conical rolling-off surfaces
11 First axis
12 Second axis
13 Tie
17 Second conical surface
18 First conical surface
20 Bendable protective sheath
21, 22 Mutually engaging projections
23 Flexible tie
23.2 Segmented tie
23.3 Flexible tie/joint element
24 Elastic segment
25 Rigid element
27 Duct
28 Bent bearing surface
30 Securing means against upward tilting
30.1 First circumferential ring
30.2 Second circumferential ring
30.3 Connecting web

1. A rotatable power generation plant for generating electric power from a flow of water, comprising:
a water turbine;
an electric generator which is driven by the water turbine;
a support body which is associated with a first axis;
a nacelle body which is associated with a second axis bent off relative to the first axis and is movable relative to the support body; a connection cable which extends from the electric generator through the nacelle body to the support body;
a hinged joint between the support body and the nacelle body with a device which transmits a rotational movement of the nacelle body about the first axis associated with the support body into a rotational movement of the nacelle body about the second axis associated with the same in such a way that twisting of the connection cable remains limited.

2. A power generation plant according to claim 1, characterized in that the transmission of a rotational movement of the nacelle body about the first axis into a rotational movement about the second axis occurs at a speed ratio of 1:1.

3. A power generation plant according to claim 1, characterized in that the nacelle body is actively twisted by means of a first axial drive about the first axis associated with the support body.

4. A power generation plant according to claim 1, characterized in that the water turbine is spaced by the nacelle body from the hinged joint and the position of the water turbine relative to the first axis associated with the support body is influenced by the water current.

5. A power generation plant according to claim 2, characterized in that the 1:1 ratio of the rotational movement about the first axis into a rotational movement about the second axis is caused by the cooperation of first forming and/or positive engagement elements associated with the support body with second form and/or positive engagement elements associated with the nacelle body and anchoring elements are provided in hinged joint which ensure the bearing contact between the first and the second form and/or positive engagement elements.

6. A power generation plant according to claim 1, characterized in that the hinged joint comprises an elastic component which is in connection both with the support body as well as the nacelle body and produces a restoring force against a tensile load and a kinking load and a twisting.

7. A power generation plant according to claim 2, characterized in that the nacelle body is actively twisted by means of a first axial drive about the first axis associated with the support body.

8. A power generation plant according to claim 2, characterized in that the water turbine is spaced by the nacelle body from the hinged joint and the position of the water turbine relative to the first axis associated with the support body is influenced by the water current.

9. A power generation plant according to claim 3, characterized in that the 1:1 ratio of the rotational movement about the first axis into a rotational movement about the second axis is caused by the cooperation of first forming and/or positive engagement elements associated with the support body with second form and/or positive engagement elements associated with the nacelle body and anchoring elements are provided in hinged joint which ensure the bearing contact between the first and the second form and/or positive engagement elements.

10. A power generation plant according to claim 4, characterized in that the 1:1 ratio of the rotational movement about the first axis into a rotational movement about the second axis is caused by the cooperation of first forming and/or positive engagement elements associated with the support body with second form and/or positive engagement elements associated with the nacelle body and anchoring elements are provided in hinged joint which ensure the bearing contact between the first and the second form and/or positive engagement elements.

11. A power generation plant according to claim 2, characterized in that the hinged joint comprises an elastic component which is in connection both with the support body as well as the nacelle body and produces a restoring force against a tensile load and a kinking load and a twisting.

12. A power generation plant according to claim 3, characterized in that the hinged joint comprises an elastic component which is in connection both with the support body as well as the nacelle body and produces a restoring force against a tensile load and a kinking load and a twisting.

13. A power generation plant according to claim 4, characterized in that the hinged joint comprises an elastic component which is in connection both with the support body as well as the nacelle body and produces a restoring force against a tensile load and a kinking load and a twisting.

14. A power generation plant according to claim 5, characterized in that the hinged joint comprises an elastic component which is in connection both with the support body as well as the nacelle body and produces a restoring force against a tensile load and a kinking load and a twisting.
